(19) United States
(12) Patent Application Publication
(10) Pub. No.: US 2026/0328130 A1
(43) Pub. Date: Oct. 22, 2026

(54) INTERNAL COMBUSTION ENGINE

(71) Applicant: TOYOTA JIDOSHA KABUSHIKI KAISHA, Toyota-shi (JP)

(72) Inventor: Kenta KURIHARA, Yokohama-shi (JP)

(21) Appl. No.: 19/417,364

(22) Filed: Dec. 12, 2025

(30) Foreign Application Priority Data
Apr. 22, 2025 (JP) 2025-070553

(51) Int. Cl. F02B 19/10; F02B 19/18; F02B 43/10; F02M 21/02

(52) U.S. Cl. CPC F02B 19/108; F02B 19/18; F02B 43/10; F02M 21/0206; F02M 21/0275

(57) ABSTRACT

An internal combustion engine includes a combustion chamber, a cylinder head including an insertion chamber communicating with the combustion chamber, and an injector inserted into the insertion chamber, including an injection port opening to the insertion chamber, and configured to inject gaseous fuel. The cylinder head includes at least one nozzle hole connecting the insertion chamber to the combustion chamber. The at least one nozzle hole includes a first opening that opens to the insertion chamber, and a second opening that opens to the combustion chamber. The first opening opens at a position not facing the injection port in a direction of a central axis of the injection port. The second opening opens at a position where a central axis of the at least one nozzle hole does not pass through the injection port in plan view as viewed from the direction of the central axis of the injection port.

### CROSS-REFERENCE TO RELATED APPLICATIONS

This application is based upon and claims the benefit of priority from Japanese Patent Application No. 2025-070553, filed on Apr. 22, 2025, the entire contents of which are incorporated herein by reference.

### BACKGROUND

### 1. Field

The present disclosure relates to an internal combustion engine.

### 2. Description of Related Art

A hydrogen engine disclosed in JP2024-069954A includes a cylinder head and an injector provided in the cylinder head. The injector injects hydrogen gas through an injection hole. The hydrogen gas injected from the injector is injected into the combustion chamber through a pressure accumulation chamber and a connection hole formed in the cylinder head.

In an internal combustion engine in which a gaseous fuel linearly flows from the injection port of the injector to the combustion chamber, for example, gas or a shock wave generated in the combustion chamber easily reaches the injection port. As a result, the injector may be susceptible to degradation.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an internal combustion engine includes a combustion chamber, a cylinder head including an insertion chamber communicating with the combustion chamber, and an injector that is inserted into the insertion chamber, includes an injection port that opens to the insertion chamber, and is configured to inject gaseous fuel. The cylinder head includes at least one nozzle hole that connects the insertion chamber to the combustion chamber. The at least one nozzle hole includes a first opening that opens to the insertion chamber, and a second opening that opens to the combustion chamber. The first opening opens at a position not facing the injection port in a direction of a central axis of the injection port. The second opening opens at a position at which a central axis of the at least one nozzle hole does not pass through the injection port in plan view as viewed from the direction of the central axis of the injection port.

Other features and aspects will be apparent from the following detailed description, the drawings, and the claims.

### BRIEF DESCRIPTION OF THE DRAWINGS

FIG. 1 is a cross-sectional view schematically showing the vicinity of a distal portion of an injector in an internal combustion engine.

FIG. 2 is a cross-sectional view taken along line 2-2 in FIG. 1.

FIG. 3 is a cross-sectional view similar to FIG. 1, further illustrating an arrow indicating the propagation direction of a shock wave.

FIG. 4 is a cross-sectional view schematically showing the vicinity of a distal portion of an injector in an internal combustion engine of a comparative example.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

An internal combustion engine according to one embodiment will now be described.

### Configuration of Internal Combustion Engine

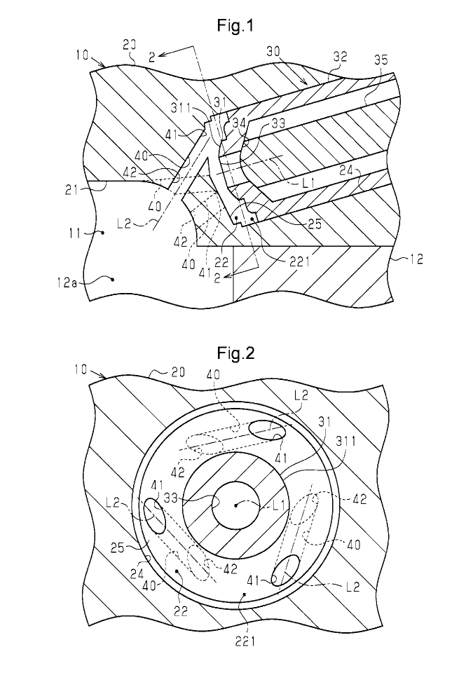

As shown in FIG. 1, an internal combustion engine 10 includes a combustion chamber 11, a cylinder block 12, a cylinder head 20, and an injector 30. The internal combustion engine 10 uses gaseous fuel. The gaseous fuel is hydrogen. That is, the internal combustion engine 10 is a hydrogen engine. The gaseous fuel is combusted in the combustion chamber 11. The internal combustion engine 10 operates a piston (not shown) by burning gaseous fuel in the combustion chamber 11.

The cylinder block 12 includes a piston chamber 12a. The piston chamber 12a is a

cylindrical space. The piston chamber 12a is a part of the combustion chamber 11. The piston chamber 12a is a portion of the combustion chamber 11 in which the piston is accommodated.

The cylinder head 20 is connected to an end portion of the cylinder block 12. The cylinder head 20 includes a cylinder head inner surface 21. The cylinder head inner surface 21 covers the piston chamber 12a. The cylinder head inner surface 21 is a part of a surface that defines the combustion chamber 11.

The cylinder head 20 includes an insertion chamber 22. The insertion chamber 22 is formed inside the cylinder head 20. The insertion chamber 22 extends in one direction. An injector 30 is inserted into the insertion chamber 22. The direction in which the insertion chamber 22 extends agrees with the direction in which the injector 30 extends.

The insertion chamber 22 is defined by an insertion chamber inner peripheral surface 24 and an insertion chamber bottom surface 25. The insertion chamber inner peripheral surface 24 extends in the extending direction of the insertion chamber 22. FIG. 1 shows a portion of the insertion chamber inner peripheral surface 24 in the vicinity of the combustion chamber 11. The insertion chamber inner peripheral surface 24 surrounds the injector 30. The insertion chamber bottom surface 25 faces the injector 30 in the direction in which the insertion chamber 22 extends. The insertion chamber bottom surface 25 is located between the combustion chamber 11 and the injector 30.

The injector 30 is inserted into the insertion chamber 22. The injector 30 extends in one direction. The injector 30 is a cylindrical body. The direction in which the injector 30 extends agrees with the direction in which the insertion chamber 22 extends. The injector 30 injects a gaseous fuel.

The injector 30 includes an injection end portion 31 and a main body portion 32. Each of the injection end portion 31 and the main body portion 32 is a part of the injector 30.

The injection end portion 31 and the main body portion 32 are arranged in a direction in which the injector 30 extends.

The injection end portion 31 is one of two end portions of the injector 30. FIG. 1 shows only the injection end portion 31 of the two end portions of the injector 30. The injection end portion 31 faces the insertion chamber bottom surface 25. The injection end portion 31 is located away from the insertion chamber bottom surface 25 in the direction in which the injector 30 extends.

The injection end portion 31 is tapered toward the distal end. Accordingly, the injector 30 is separated from the insertion chamber inner peripheral surface 24 at the injection end portion 31. An outer surface 311 of the injection end portion 31 and the insertion chamber inner peripheral surface 24 define a gap 221. The gap 221 is included in the insertion chamber 22.

The injector 30 includes an injection port 33. The injection port 33 opens at the injection end portion 31. The injection port 33 opens to the insertion chamber 22. The interior of the injector 30 communicates with the insertion chamber 22 via the injection port 33. The injection port 33 extends in one direction. The direction in which the injection port 33 extends agrees with the direction in which the injector 30 extends. A central axis L1 of the injection port 33 agrees with a central axis of the injector 30. The central axis L1 of the injection port 33 agrees with a central axis of the insertion chamber 22.

The main body portion 32 is a cylindrical body. The inside of the main body portion 32 communicates with the insertion chamber 22 via the injection port 33. The main body portion 32 faces the insertion chamber inner peripheral surface 24 in the radial direction of the main body portion 32. The main body portion 32 is in contact with the insertion chamber inner peripheral surface 24.

The main body portion 32 includes a valve seat 34. A needle valve 35 is accommodated in the main body portion 32. The valve seat 34 is a portion of the inner surface of the main body portion 32 around the injection port 33 and faces the needle valve 35. The needle valve 35 is a columnar body. The diameter of the needle valve 35 is smaller than the inner diameter of the main body portion 32. The needle valve 35 reciprocates in a direction in which the injector 30 extends inside the main body portion 32. The needle valve 35 comes into contact with or separates from the valve seat 34 by reciprocating. The needle valve 35 is exposed to the outside of the injector 30 through the injection port 33.

The injector 30 can be switched between a state where the injection port 33 opens and a state where the injection port 33 is closed by the needle valve 35. In the injector 30 shown in FIG. 1, the injection port 33 is closed. The needle valve 35 opens the injection port 33 by moving away from the valve seat 34. The needle valve 35 closes the injection port 33 by contacting the valve seat 34.

### Nozzle Holes

The cylinder head 20 includes multiple nozzle holes 40. In the present embodiment, the cylinder head 20 includes three nozzle holes 40. Each nozzle hole 40 is located between the combustion chamber 11 and the insertion chamber 22 in the cylinder head 20. Each nozzle hole 40 connects the insertion chamber 22 to the combustion chamber 11. In other words, the insertion chamber 22 communicates with the combustion chamber 11. FIG. 1 shows a cross section of one of the three nozzle holes 40.

As shown in FIG. 2, each nozzle hole 40 includes a first opening 41 and a second opening 42. That is, the cylinder head 20 includes multiple first openings 41 and multiple second openings 42. In the present embodiment, the cylinder head 20 includes three first openings 41 and three second openings 42.

Each nozzle hole 40 extends in a direction connecting the first opening 41 and the second opening 42. A central axis L2 of each nozzle hole 40 is a straight line connecting the

center of the first opening 41 and the center of the second opening 42. The central axis L2 of each nozzle hole 40 extends in a direction different from the central axes L2 of the other two nozzle holes 40.

The first openings 41 open to the insertion chamber 22. The first openings 41 open in the insertion chamber bottom surface 25. An opening edge of each first opening 41 is positioned on the insertion chamber bottom surface 25. The first openings 41 face the injection end portion 31. A part of the injection end portion 31 shown in cross section in FIG. 2 does not face any of the first openings 41. The cross section of the nozzle hole 40 in FIG. 1 is a cross section including the central axis L2 of the nozzle hole 40. The cross section of the injector 30 in FIG. 1 is a cross section including the central axis L1 of the injection port 33.

As shown in FIG. 2, in plan view seen from the direction of the central axis L1 of the injection port 33, the injection end portion 31 includes a part that surrounds the injection port 33 at a location closer to the central axis L1 of the injection port 33 than the first opening 41 is. The injection end portion 31 includes a part that does not face any of the first openings 41 in the direction in which the central axis L1 of the injection port 33 extends.

Each first opening 41 opens at a position not facing the injection port 33 in the direction of the central axis L1 of the injection port 33. In other words, the injection port 33 faces a part of the insertion chamber bottom surface 25 in which none of the first openings 41 is located in the direction of the central axis L1. In plan view of the insertion chamber bottom surface 25 as viewed from the direction of the central axis L1 of the injection port 33, the opening edge of each first opening 41 does not overlap the opening edge of the injection port 33.

The first openings 41 are positioned at equal intervals in the circumferential direction around the central axis L1 of the injection port 33. Specifically, the center of each of the first openings 41 is located midway between the centers of the other two first openings

41 in the circumferential direction around the central axis L1. In the plan view as viewed from the direction of the central axis L1, the distance between the center of one of the first openings 41 and the center of the injection port 33 is equal to the distance between the center of the injection port 33 and the center of each of the other two first openings 41.

The second openings 42 open to the combustion chamber 11. The second openings 42 open in the cylinder head inner surface 21. An opening edge of each second opening 42 is located on the cylinder head inner surface 21. Each of the nozzle holes 40 has a circular passage shape in a cross section orthogonal to the central axis L2. The hole diameter of each nozzle hole 40 is constant in the direction of the central axis L2. Accordingly, the shape of the second opening 42 agrees with the shape of the first opening 41. All of the nozzle holes 40 have the same cross-sectional flow area.

Each second opening 42 opens at a position where the central axis L2 of the nozzle hole 40 does not pass through the injection port 33 in plan view as viewed from the direction of the central axis L1. Accordingly, the first opening 41, the second opening 42, and the injection port 33 are not arranged on the same straight line. In plan view as viewed from the direction of the central axis L1, the direction from the second opening 42 toward the first opening 41 is different from the direction from the first opening 41 toward the injection port 33.

### Operation of the Present Embodiment

Operation of the present embodiment will now be described.

The injector 30 injects the supplied hydrogen into the insertion chamber 22. The fuel is injected from the injection port 33 in the direction of the central axis L1 of the injection port 33. The injected hydrogen flows into the nozzle hole 40 from the first opening 41. The hydrogen flowing in the nozzle hole 40 flows into the combustion chamber 11 from the second opening 42.

In the internal combustion engine 10, a shock wave may be generated due to abnormal combustion of hydrogen in the combustion chamber 11, for example, pre-ignition. The shock wave propagates from the inside of the combustion chamber 11 to the insertion chamber 22 through the nozzle hole 40. FIG. 3 shows the direction of propagation of the shock wave by means of arrows. The shock wave propagates toward the injection port 33 after passing through the nozzle hole 40. The propagation path of the shock wave is refracted twice from the inside of the nozzle hole 40 to the inside of the injection port 33. More specifically, the propagation direction of the shock wave is refracted from the direction of the central axes L2 of the nozzle holes 40 to a direction substantially orthogonal to the central axis L1 of the injection port 33. Further, the propagation direction of the shock wave is refracted from the direction substantially orthogonal to the central axis L1 of the injection port 33 to the direction of the central axis L1 of the injection port 33.

Due to the combustion flame, high-temperature and high-pressure gas may be generated in the combustion chamber 11. A portion of the gas generated in the combustion chamber 11 flows from the combustion chamber 11 toward the injection port 33. Similarly to the propagation direction of the shock wave, the traveling direction of the gas is refracted twice from the inside of the nozzle hole 40 to the inside of the injection port 33.

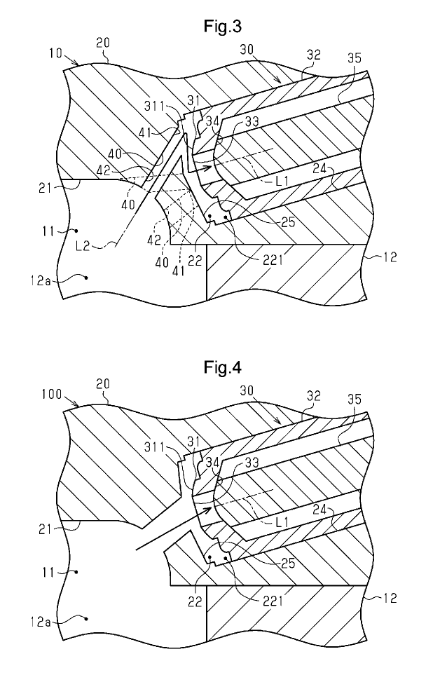

FIG. 4 shows an internal combustion engine 100 of a comparative example. In the internal combustion engine 100, an opening corresponding to the first opening 41 faces the injection port 33. In the internal combustion engine 100, the insertion chamber 22 is connected to the combustion chamber 11 by one hole. The internal combustion engine 100 is provided with a hole having a larger hole diameter than each nozzle hole 40 in order to allow the same amount of gaseous fuel as the three nozzle holes 40 of the internal combustion engine 10 to pass through.

In the internal combustion engine 100, a shock wave or gas generated in the combustion chamber 11 passes through a hole corresponding to the nozzle hole 40, and then directly reaches the injection port 33. The shock wave or the gas generated in the internal combustion engine 100 reaches the injection port 33 via a shorter distance than the shock wave or the gas generated in the internal combustion engine 10.

### Advantages of Present Embodiment

The present embodiment has the following advantages.
(1) Even if the shock wave propagates or the gas reversely flows from the combustion chamber 11 toward the insertion chamber 22, the gas or the shock wave does not directly reach the injection port 33 from the combustion chamber 11. The gas or the shock wave collides with the wall surface inside the insertion chamber 22, turns around by changing direction, and reaches the injection port 33. That is, in the internal combustion engine 10, even when the shock wave or the gas enters the insertion chamber 22 through the nozzle hole 40, the shock wave or the gas can be attenuated before the injection port 33. As a result, the internal combustion engine 10 can reduce the influence of the shock wave or the gas on the valve seat 34 and the needle valve 35. As described above, the internal combustion engine 10 can suppress deterioration of the injector 30.
(2) In all of the nozzle holes 40, the first opening 41 opens at a position that does not face the injection port 33 in the direction of the central axis L1 of the injection port 33. Further, in all the nozzle holes 40, the second openings 42 open at positions where the central axes L2 of the nozzle holes 40 do not pass through the injection port 33 in plan view as viewed from the direction of the central axis L1. Therefore, the shock wave or the gas flowing from the combustion chamber 11 toward the insertion chamber 22 does not directly reach the injection port 33 even when the shock wave or the gas passes through any nozzle hole 40. As a result, the internal combustion engine 10 can further suppress deterioration of the injector 30, for example, compared to a case where only one of the multiple nozzle holes 40 has the above-described configuration.
(3) The internal combustion engine 10 uses hydrogen as the gaseous fuel. The gas fuel has a lower molecular number density than the liquid fuel. Therefore, it is desirable that the internal combustion engine 10 using the gas fuel includes the nozzle hole 40 having a larger cross-sectional flow area than that of the internal combustion engine using the liquid fuel. According to the above configuration, the internal combustion engine 10 can suppress the deterioration of the injector 30 while increasing the flow rate of the gas fuel from the insertion chamber 22 to the combustion chamber 11.
(4) The three first openings 41 are arranged at equal intervals in the circumferential direction around the central axis L1 of the injection port 33. For this reason, it is possible to avoid the first opening 41 from being unevenly disposed in a part of the inside of the insertion chamber 22. As a result, the internal combustion engine 10 can suppress the fuel from remaining inside the insertion chamber 22 due to a part of the gas fuel being injected to a position far from the first opening 41 in the insertion chamber 22.
(5) The insertion chamber 22 includes the gap 221 between the outer surface 311 of the injection end portion 31 and the insertion chamber inner peripheral surface 24. For example, when the gas flows backward from the combustion chamber 11 to the insertion chamber 22, a part of the gas flows toward the gap 221. In this way, it is possible to lengthen a path through which a part of the gas flows until reaching the injection port 33. Similarly, in a case where the shock wave propagates from the combustion chamber 11 to the insertion chamber 22, a part of the shock wave propagates toward the gap 221. Therefore, it is possible to lengthen the propagation path until a part of the shock wave reaches the injection port 33. As described above, the internal combustion engine 10 can further attenuate the shock wave or the gas in front of the injection port 33 as compared with the case where the gap 221 is not provided.

### Modifications

The above embodiment may be modified as follows. The above-described embodiment and the following modifications can be combined as long as the combined modifications remain technically consistent with each other.

The portion of the injection end portion 31 surrounding the injection port 33 may not be located at a position closer to the central axis L1 than the first opening 41 in the plan view seen from the direction of the central axis L1 of the injection port 33. For example, in plan view as viewed from the direction of the central axis L1, a portion of the injection end portion 31 surrounding the injection port 33 may overlap the first opening 41. For example, as long as the outer surface 311 is inclined so as to approach the central axis L1 toward the front end side where the opening edge of the injection port 33 is located, the gap 221 can be formed similarly to the above-described embodiment even when the portion of the injection end portion 31 surrounding the injection port 33 overlaps the first opening 41 in the plan view seen from the direction of the central axis L1.

The outer diameter of the injection end portion 31 may not be smaller than the hole diameter of the insertion chamber 22. The injection end portion 31 may have an outer diameter that allows the injector 30 to be inserted into the insertion chamber 22.

The three first openings 41 may be arranged in a concentrated manner in plan view as viewed from the direction of the central axis L1 of the injection port 33. In short, the positions of the three first openings 41 in the insertion chamber bottom surface 25 are arbitrary.

The gaseous fuel may be other than hydrogen. The gaseous fuel may be, for example, CNG or LPG.

At least one nozzle hole 40 of the multiple nozzle holes 40 may have the above-described configuration. For example, the internal combustion engine 10 may include one nozzle hole 40 having the above-described configuration and two nozzle holes 40 extending in parallel to the direction of the central axis L1 of the injection port 33. Even in such a configuration, the deterioration of the injector 30 can be suppressed as compared with the case where all the nozzle holes 40 are provided toward the injection port 33.

The internal combustion engine 10 may not include three nozzle holes 40. The internal combustion engine 10 may include at least one nozzle hole 40.

The internal combustion engine 10 may include three or more nozzle holes 40.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuitry are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An internal combustion engine, comprising:
a combustion chamber;
a cylinder head including an insertion chamber communicating with the combustion chamber; and
an injector that is inserted into the insertion chamber, includes an injection port that opens to the insertion chamber, and is configured to inject gaseous fuel, wherein
the cylinder head includes at least one nozzle hole that connects the insertion chamber to the combustion chamber,
the at least one nozzle hole includes:
a first opening that opens to the insertion chamber; and
a second opening that opens to the combustion chamber,
the first opening opens at a position not facing the injection port in a direction of a central axis of the injection port, and
the second opening opens at a position at which a central axis of the at least one nozzle hole does not pass through the injection port in plan view as viewed from the direction of the central axis of the injection port.

2. The internal combustion engine according to claim 1, wherein the at least one nozzle hole is one of two or more nozzle holes.

3. The internal combustion engine of claim 1, wherein the gaseous fuel is hydrogen.

4. The internal combustion engine according to claim 2, wherein the first opening is one of multiple first openings respectively provided in the two or more nozzle holes, the first openings being positioned at equal intervals in a circumferential direction around the central axis of the injection port.

5. The internal combustion engine according to claim 1, wherein
the injector includes an injection end portion that faces the first opening and in which the injection port opens, and
in plan view seen from the direction of the central axis of the injection port, the injection end portion includes a part that surrounds the injection port at a location closer to the central axis of the injection port than the first opening is.
